(19) United States
(12) Patent Application Publication
(10) Pub. No.: US 2013/0203509 A1
(43) Pub. Date: Aug. 8, 2013

(54) VIRTUAL LOCATION CHECK-IN

(71) Applicants: David R. Reed, Seattle, WA (US); John P. Bruno, Snoqualmie, WA (US)

(72) Inventors: David R. Reed, Seattle, WA (US); John P. Bruno, Snoqualmie, WA (US)

(73) Assignee: MICROSOFT CORPORATION, Redmond, WA (US)

(21) Appl. No.: 13/366,046

(22) Filed: Feb. 3, 2012

(51) Int. Cl. G06F 19/00

(52) U.S. Cl. 463/43

(57) ABSTRACT

Virtual location information is received at one or more devices as part of a virtual location check-in request for a user. The virtual location information identifies a virtual location of the user in a virtual environment. A notification of the virtual location of the user in the virtual environment is sent from the one or more devices to one or more additional users external to the virtual environment. One or more gameplay features can also be made available to the user based on the virtual location.

### BACKGROUND

Computer games have evolved as computing technology has advanced. Where computer games were once relatively straightforward single-player games, many have evolved to become complex multi-player games including some massively multiplayer online (MMO) games that allow large numbers of players to play online concurrently. However, given the size and complexity of such games, it can be difficult for players to operate in and use such games, leading to user frustration when playing such games.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, virtual location information is received at one or more devices. The virtual location information identifies a virtual location of a user in a virtual environment. A notification of the virtual location of the user in the virtual environment is sent to one or more additional users external to the virtual environment.

In accordance with one or more aspects, a virtual location check-in request for a user is received. The virtual location check-in request includes virtual location information identifying a virtual location of the user in a virtual environment. Based on the virtual location identified in the virtual location check-in request, one or more gameplay features are provided.

### BRIEF DESCRIPTION OF THE DRAWINGS

The same numbers are used throughout the drawings to reference like features.

FIG. 1 illustrates an example system implementing the virtual location check-in in accordance with one or more embodiments.

FIG. 2 illustrates another example system implementing the virtual location check-in in accordance with one or more embodiments.

FIG. 3 illustrates an example user interface that can be displayed to a user to allow the user to select whether virtual locations of the user will be tracked in accordance with one or more embodiments.

FIG. 4 is a flowchart illustrating an example process for implementing the virtual location check-in in accordance with one or more embodiments.

FIG. 5 illustrates an example system that may implement the various techniques described herein.

### DETAILED DESCRIPTION

Virtual location check-in is discussed herein. A user of a program (e.g., a game) can check-in to have a virtual location of the user in a virtual environment of the program identified and used in various manners. The virtual location can be provided to other users of the same program and/or different programs, allowing those other users to join and/or assist the particular user. The virtual location of the user in the virtual environment can also be compared to physical locations in the real world, and a determination made as to when an avatar is at a virtual location that corresponds to a physical location in the real world. Various program features can be made available to the particular user when his or her avatar is at a virtual location that corresponds to a physical location in the real world.

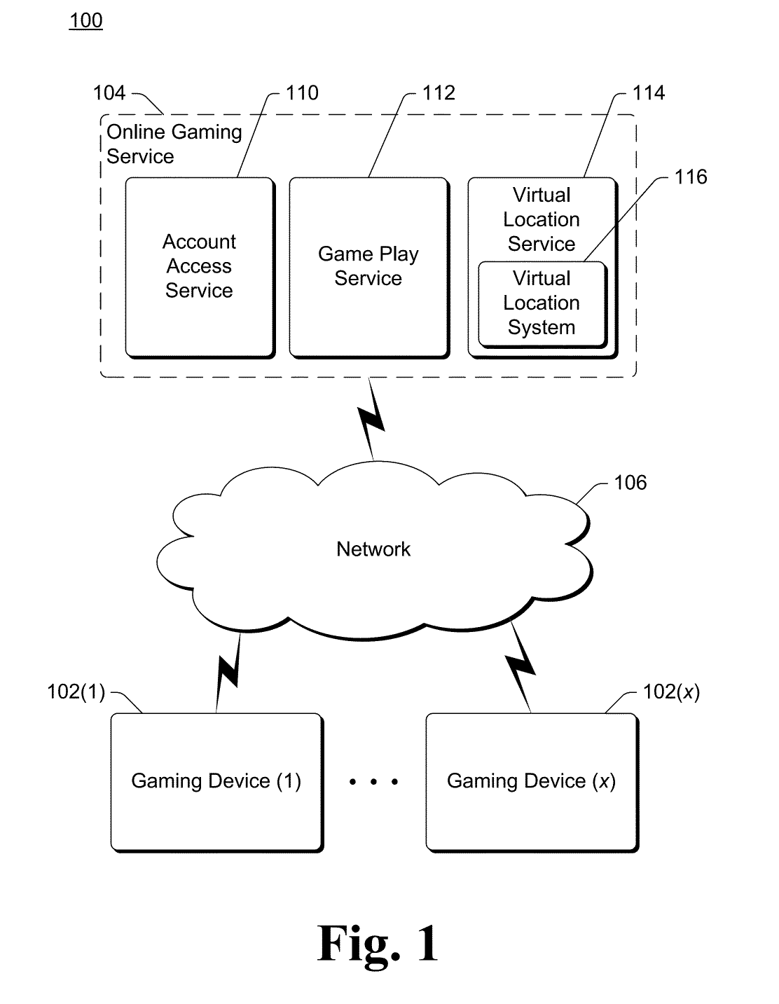

FIG. 1 illustrates an example system 100 implementing the virtual location check-in in accordance with one or more embodiments. System 100 includes multiple (x) gaming devices 102 and an online gaming service 104 that can communicate with one another via a network 106. Network 106 can be a variety of different networks, including the Internet, a local area network (LAN), a wide area network (WAN), a personal area network (PAN), a phone network, an intranet, other public and/or proprietary networks, combinations thereof, and so forth.

Each gaming device 102 can be a variety of different types of devices that allow users to run programs that implement a virtual environment. These programs are discussed herein as games, and it should be noted that the virtual location check-in techniques discussed herein can be used with any program implementing or using a virtual environment even if not commonly referred to as a game. Games can be any of a variety of different single-player and/or multi-player games including various competitions, challenges. and/or other objectives, such as sports games, strategy games, adventure games, simulation games, and so forth. Different ones of gaming devices 102 can be the same or different types or configurations of devices. For example, a gaming device 102 can be a game console, a cellular or other wireless phone, a television or other display device, a set-top box communicatively coupled to a display device, a desktop computer, a laptop or netbook computer, a tablet or notepad computer, a mobile station, an entertainment appliance, an automotive computer, and so forth.

Online gaming service 104 facilitates playing of one or more different games by users of gaming devices 102. Gaming service 104 is referred to as being an online service due to gaming devices 102 accessing service 104 (and/or other gaming devices 102) via network 106. Online gaming service 104 includes an account access service 110, a game play service 112, and a virtual location service 114, each of which can communicate with one another. Services 110, 112, and 114 can communicate with one another within online gaming service 104 and/or via gaming devices 102.

Account access service 110 provides various functionality supporting user accounts of online gaming service 104. Different users and/or gaming devices 102 typically have different accounts with online gaming service 104, and can log into their accounts via account access service 110. A user or gaming device 102 logs into an account providing credential information, such as an ID (e.g., user name, email address, etc.) and password, a digital certificate or other data from a smartcard, and so forth. Account access service 110 verifies or authenticates the credential information, allowing a user or gaming device 102 to access the account if the credential information is verified or authenticated, and prohibiting the user or gaming device 102 from accessing the account if the credential information is not verified or is not authenticated. Once a user's credential information is authenticated, the user can use the other services provided by online gaming service 104. Account access service 110 can also provide various additional account management functionality, such as permitting changes to the credential information, establishing new accounts, removing accounts, and so forth.

Game play service 112 provides various functionality supporting playing of one or more different games by users of gaming devices 102. Different game titles can be supported by game play service 112 (e.g., one or more different sports game titles, one or more different strategy game titles, one or more different travel or searching game titles, and so forth). A game title refers to a set of instructions that implement a game when executed (e.g., a set of instructions for a tennis game from a particular vendor, a set of instructions for a particular racing game from a particular vendor, etc.). A particular running of a game title is also referred to as a game. Multiple games of the same game title can be played concurrently by different users, each game being a separate running of the game title. Games can be run and played as single-player games in which a single user of a gaming device 102 is playing the game and controlling one or more characters in the game, with other characters in the game being controlled by the game itself (these other characters also being referred to as non-player-characters). Games can also be run and played as multi-player games in which multiple users of one or more gaming devices 102 are playing the same game and each user is controlling one or more characters in the game. In multi-player games one or more additional characters can also be controlled by the game itself.

A game is typically run by executing one or more programs. The programs that are executed to run these games can be run on gaming devices 102 and/or game play service 112. Gaming devices 102 can execute one or more programs for the game, communicating with game play service 112 to facilitate communication between users of gaming devices 102 while playing games and/or to provide or obtain additional data (and/or programs) for playing the game. Alternatively (or additionally), game play service 112 can execute one or more programs for the game, receiving inputs from users of gaming devices 102 and returning data indicating outputs to be generated for display or other presentation to the users of gaming devices 102. Although discussed herein as one or more programs that are executed on gaming devices 102 and/or game play service 112, it should be noted that a game can be implemented at least in part in hardware at gaming devices 102 and/or game play service 112.

In one or more embodiments, games are programs executed on gaming devices 102 and game play service 112 manages communication between different gaming devices 102. In other embodiments, games are programs executed on gaming devices 102 and game play service 112 facilitates establishing communication between different gaming devices 102. After communication between two gaming devices 102 is established, communication can be made between those two gaming devices 102 without involving game play service 112.

Virtual location service 114 includes a virtual location system 116 that provides virtual location functionality for different games of the same and/or different game titles. This virtual location functionality allows various virtual locations in a virtual environment to be identified. A virtual environment refers to an environment that exists in one or more games rather than a real world environment. A virtual location refers to a location within the virtual environment rather than a physical location in the real world. In the illustrated example, virtual location system 116 is implemented in a separate service from game play service 112 and supports virtual location functionality across multiple different game titles. Alternatively, virtual location system 116 can support virtual location functionality for one game title, and can optionally be included as part of game play service 112.

In one or more embodiments, a virtual location of a user corresponds to the virtual location of the user in the virtual environment. An avatar of the user can be displayed to the user, or alternatively no avatar may be displayed (e.g., a first person view may be displayed for the user). An avatar refers to an object that represents the user in a game. An avatar is oftentimes a graphical representation of the user, but can alternatively have a variety of other forms, such as a vehicle, an orb, and so forth.

Each of services 110, 112, and 114 can be implemented using one or more computing devices. Typically these computing devices are server computers, but any of a variety of different types of computing devices can alternatively be used (e.g., any of the types of devices discussed above with reference to gaming device 102). Each of services 110, 112, and 114 can be implemented using different computing devices, or alternatively one or more of services 110, 112, and 114 can be implemented using the same computing device.

Additionally, although services 110, 112, and 114 are illustrated as separate services, alternatively multiple ones of these services can be implemented together as a single service. For example, game play service 112 and virtual location service 114 can be implemented as a single service. Furthermore, the functionality of one or more of services 110, 112, and 114 can be separated into multiple services. In addition, the functionality of online gaming service 104 can be separated into multiple services. For example, online gaming service 104 may include account access service 110 and game play service 112, and a different service can include virtual location service 114.

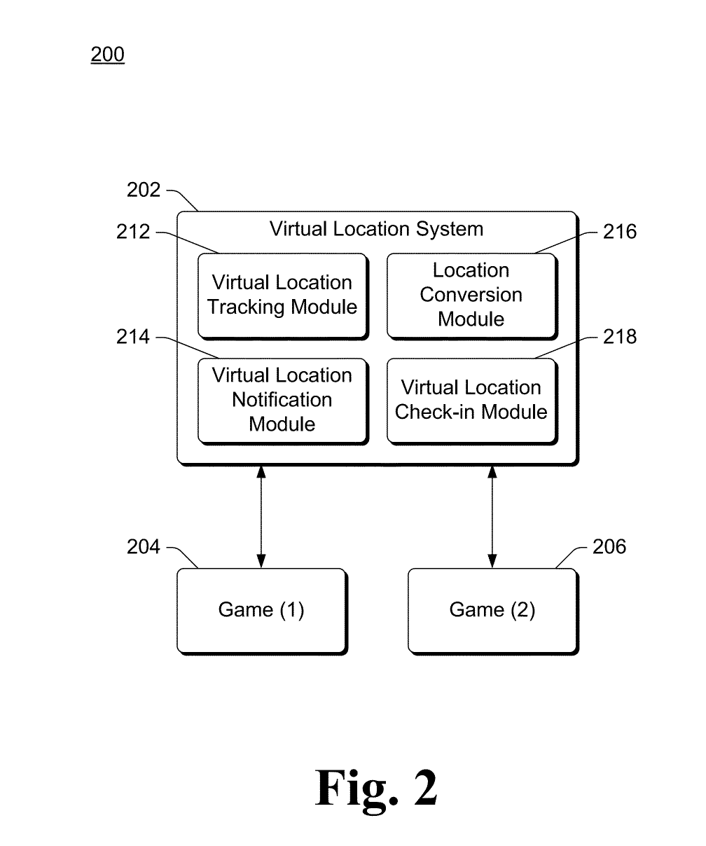

FIG. 2 illustrates an example system 200 implementing the virtual location check-in in accordance with one or more embodiments. System 200 includes a virtual location system 202 and two games 204, 206. Virtual location system 202 can be, for example, a virtual location system 116 of FIG. 1. Games 204, 206 can be different games of the same game title, or different games of different game titles. Games 204, 206 can be implemented on gaming devices (e.g., gaming devices 102 of FIG. 1) and/or an online gaming service (e.g., online gaming service 104 of FIG. 1). System 200 is discussed with reference to two games for ease of explanation, although it should be noted that any number of games can communicate with virtual location system 202.

Virtual location system 202 includes a virtual location tracking module 212, a virtual location notification module 214, a location conversion module 216, and a virtual location check-in module 218. Although modules 212-218 are illustrated as separate modules, alternatively multiple ones of modules 212-218 can be implemented together as a single module. Additionally and/or alternatively, the functionality of one or more of modules 212-218 can be separated into multiple modules.

System 200 can be implemented in a variety of different devices. For example, system 200 can be implemented in one or more gaming devices 102 of FIG. 1, in online gaming service 104 of FIG. 1, or partly in one or more gaming devices 102 and partly in online gaming service 104. Thus, the virtual location check-in techniques discussed herein can be implemented in an online gaming service and/or individual gaming devices.

In one or more embodiments virtual location system 202 is implemented separately from, and as part of a service made available to, games 204 and 206. Alternatively, virtual location system 202 can be implemented (at least in part) in games 204 and 206. Thus, for example, game 204 and/or game 206 can include one or more of modules 212-218, or can implement at least part of the functionality discussed herein as performed by modules 212-218.

Virtual location tracking module 212 allows the virtual locations of users in a virtual environment to be tracked. A record of the virtual locations of users can be maintained by module 212, or the virtual locations can be provided to and maintained by another module (e.g., a module of game 204 and/or 206). Various gameplay features can be made available to users based on their virtual locations, as discussed in more detail below.

Virtual location notification module 214 allows notifications of the virtual location of a user in a virtual environment to be sent. These notifications can be sent to various other services or users as discussed in more detail below. These notifications can also include an indication of the virtual location allowing other users to join the user at that virtual location as discussed in more detail below.

Location conversion module 216 allows real world locations to be converted to virtual locations and/or vice versa. This conversion allows various gameplay features to be made available to users as discussed in more detail below.

Virtual location check-in module 218 allows games 204 and 206 to provide virtual location information to virtual location system 202. The virtual location information is typically provided as part of a virtual location check-in request, although can alternatively be provided in other manners.

Virtual location system 202 supports a virtual environment mapping system. The virtual environment mapping system defines a coordinate system that is used to identify virtual locations within a virtual environment. This coordinate system is typically a 3-dimensional (3D) coordinate system, although can alternatively include any other number of dimensions. In one or more embodiments, the coordinate system is a Cartesian coordinate system including x, y, and z dimensions (e.g., horizontal, vertical, and depth). Alternatively, various other coordinate systems can be used, such as a spherical coordinate system (with radial distance, inclination angle, and azimuth angle as the dimensions), a geographic coordinate system (e.g., with latitude, longitude, and elevation as the dimensions), and so forth.

Different game titles can use the same coordinate system, or alternatively different coordinate systems. In situations in which different game titles use different coordinate systems, a conversion technique is used (e.g., by virtual location tracking module 212 or virtual location check-in module 218) to convert coordinates in the different game titles to the coordinate system of the other game titles. This conversion technique can include various different rules, criteria, algorithms, and so forth based on the different coordinate systems.

Games 204 and 206 can implement the same virtual environment and/or different virtual environments. For example, different game titles can implement their own individual virtual environments in which users play, or can share a common virtual environment in which users play. Furthermore, within a virtual environment multiple different maps can be supported. Each different map refers to a different section or portion of the virtual environment implemented by the game title. How many maps are supported and the nature of those different maps (e.g., how the different sections or portions are identified or determined) can vary by game title based on the desires of the game title designer or developer.

Virtual location check-in module 218 allows games 204 and 206 to provide virtual location information to virtual location system 202. Games 204 and 206 make virtual location check-in requests to provide (check-in) the virtual locations to virtual location system 202. In one more embodiments, virtual location check-in module 218 implements an application programming interface (API) that can be invoked by games 204 and 206 to provide virtual location information to system 202. Alternatively, games 204 and 206 can provide virtual location information to system 202 using other data transfer mechanisms.

The virtual location information identifies a virtual location of a user in a virtual environment. In one or more embodiments, the virtual location information includes values for the three dimensions in the coordinate system of the virtual environment indicating the virtual location of the user. The virtual location information can also include additional information regarding the virtual location and/or virtual environment. For example, the virtual location information can include a game title identifier that identifies the game title implementing the virtual environment in which the identified virtual location exists. Alternatively, the game title implementing the virtual environment in which the identified virtual location exists can be inherent when providing the virtual location information (e.g., different virtual location check-in modules 218 can be used for different game titles, different API methods can be exposed for different game titles, and so forth). By way of another example, the virtual location information can include a map identifier that identifies the map of the virtual environment in which the identified virtual location exists. Alternatively, the map of the virtual environment in which the identified virtual location exists can be inherent when providing the virtual location information (e.g., different virtual location check-in modules 218 can be used for different maps, different API methods can be exposed for different maps, and so forth), or the game title may have a single map in which case a map identifier need not be included in the virtual location information.

A game 204, 206 can provide the virtual location information for a user to virtual location check-in module 218 at various times. For example, a game 204, 206 can provide the virtual location information for a user at regular or irregular intervals as that user plays the game 204, 206. A game 204, 206 can also provide the virtual location information in response to particular events, such as a user input requesting his or her virtual location be provided, the user being at a particular virtual location in the virtual environment, a particular activity having been performed in the game, a particular achievement or goal having been accomplished in the game, and so forth.

The virtual location information received by virtual location check-in module 218 can be used in various manners. In one or more embodiments, the virtual location information is maintained by virtual location tracking module 212. The virtual location information can also be maintained by the game 204, 206 that provided the virtual location information (e.g., the game 204, 206 can keep a record of the virtual information it provided, or receive (e.g., in response to a request for) the recorded virtual information from virtual location tracking module 212).

The virtual location information received by virtual location check-in module 218 can also be used by virtual location notification module 214 to send notifications of the virtual location of the user in the virtual environment. These notifications can be sent to various other users, and the particular one or more users to which a notification is sent can be determined in various manners. It should be noted that these other users can be, and oftentimes are, external to the virtual environment. A user being external to the virtual environment refers to a user that is not currently playing a game implementing the virtual environment.

In one or more embodiments, the user for which the virtual location information is being provided identifies the other users (e.g., by gamer tag, email address, or other user identifier). The other users can be identified at various times, such as when the user for which the virtual location information is being provided begins playing a game, when the virtual location information is provided, as part of a configuration or preferences setting (e.g., of online gaming service 104 of FIG. 1), and so forth. Alternatively, the particular one or more users to which a notification is sent can be determined in other manners, such as users that are friends of (e.g., as identified by online gaming service 104 of FIG. 1, as identified by a social networking service, etc.) the user for which the virtual location information is being provided, users that have registered or otherwise requested to receive such notifications, and so forth.

Virtual location notification module 214 can send the notifications in various manners, optionally leveraging one or more other services. For example, the notifications can be sent via SMS (Short Message Service) messages, MMS (Multimedia Messaging Service messages), email messages, microblogging service messages (e.g., tweets), and so forth. Such notifications can be displayed to the recipient using any of a variety of well-known techniques. The notifications can also be sent via in-game communication mechanisms and displayed in-game to the recipients. For example, a particular message window or frame can be created in which the notification is displayed, the notification can be displayed in an in-game panel or other location in which messages are displayed, and so forth.

The notification can include various information regarding the user for which the virtual location information is being provided, the game title being played by the user for which the virtual location information is being provided, the virtual environment including the virtual location, and so forth. For example, the notification can identify the user for which the virtual location information is being provided (e.g., a gamer tag, email address, or other user identifier). By way of another example, various parts of the virtual location information can also be included in the notification, such as an identifier (e.g., name) of the game title being played by the user for which the virtual location information is being provided, the virtual environment that includes the virtual location, and so forth.

In one or more embodiments, the notification includes a user-selectable link (e.g., a hyperlink, button, icon, etc.). The link identifies a location or functionality of online gaming service 104 of FIG. 1 (e.g., of virtual notification module 214), and embedded in the link is an identifier of a game title, a game map, and a virtual location. The game title is the game title being played by the user for which the virtual location information is being provided. The game map is the map of the virtual environment in which the virtual location included in the virtual location information is located. The virtual location is the virtual location in the provided virtual location information.

By way of example, the user-selectable link could take the form of:
system://launch?titleID=F3R529&map=foo&loc=x.y.z
   where “F3R529” is an identifier of the game title, “foo” is an identifier of the game map, and “x.y.z” is the virtual location.

A user that receives the notification can select the link, and in response to user selection of the link, online gaming service 104 (e.g., virtual location notification module 214) notifies a game on the receiving user's device to jump to the virtual location of the game of the identified game title and game map (as identified in the link). If a game of the identified game title is not already running on the receiving user's device, then online gaming service 104 also notifies the receiving user's gaming device to begin running a game of the identified game and the identified game title. The receiving user can then join in playing the game with the user for which the virtual location information was provided.

A user's gaming device can be notified to begin running a game in various manners. For example, the user's gaming device can include a launcher module or application that receives notifications to begin running games from online gaming service 104. In response to such a notification, the launcher module or application begins running the game identified by online gaming service 104.

For example, assume game 204 is running on a gaming device A. Virtual location information is provided to virtual location check-in module 218 identifying a virtual location of a user of gaming device A. Virtual location notification module 214 provides a notification of this virtual location to a friend of the user on a gaming device B. The notification includes a link that identifies functionality of module 214. The link is selected by the friend, and in response gaming device B notifies module 214 that the link has been selected, and module 214 notifies gaming device B to begin running game 206 (which is the same game title as game 204) on gaming device B. Module 214 also notifies game 206 to place the friend at a virtual location in game 206 that is the same virtual location as is identified in the notification (or within a threshold distance of the virtual location identified in the notification). Accordingly, the friend can begin playing game 206 (which is a game of the same game title as game 204) at the same virtual location as the user for which the notification was provided.

In one or more embodiments, a game title can be run in different modes and/or different game titles can be run in response to user selection of a link in a notification. For example, a game may have a first person mode in which the user plays the game as if he or she were in the virtual environment, and a command mode in which the user coordinates groups of characters (or other game elements). By way of another example, one game title may be played in a first person mode in which the user plays the game as if he or she were in the virtual environment, and another game title may be played in a command mode in which the user coordinates groups of characters (or other game elements). Which game mode or game title is used (and launched if not already running) can be determined in different manners. In one or more embodiments, the user that will be playing the game selects the game mode or game title. For example, virtual location notification module 214 can notify the gaming device of the user to jump to the virtual location of the game of an identified game title and game map, and in response the gaming device presents a user interface requesting the user of the gaming device to select a game mode or game title. In response to the user selection of a game mode or game title, the user selected game title (or game mode of the game title identified by module 214) is run, with the user being placed at the identified virtual location.

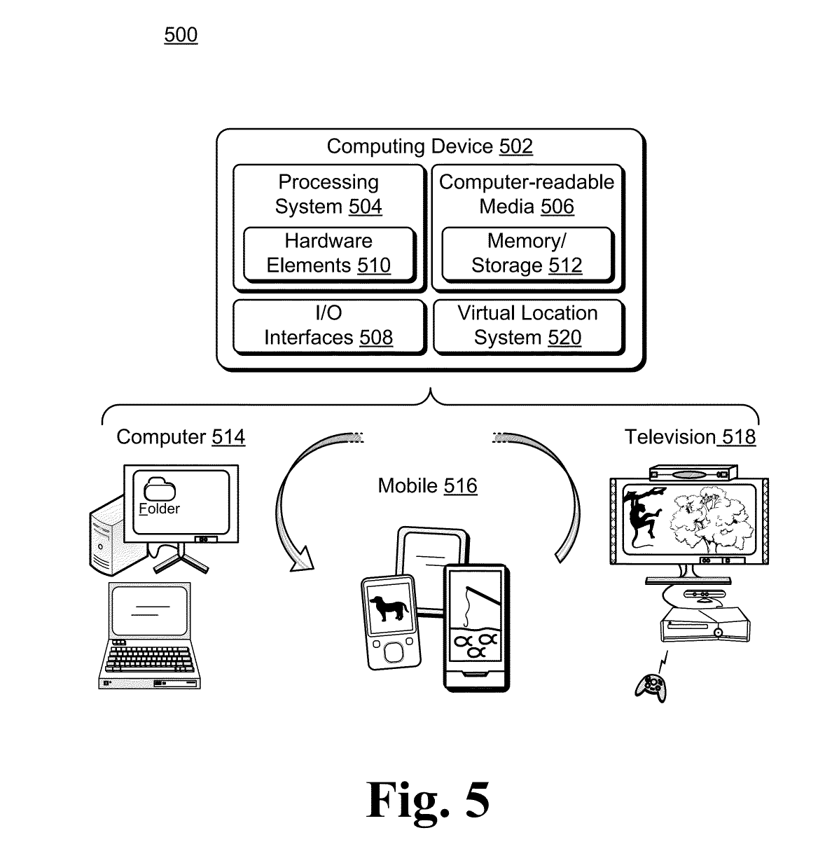

Which game mode or game title is used (and launched if not already running) can alternatively be determined in other manners. For example, the mode of the game can be included in the virtual location information provided to virtual location check-in module 218, and can be embedded in the link included in the notification sent by virtual location notification module 214. By way of another example, different device configurations can use particular game modes or game titles by default. E.g., computer configurations (e.g., computer 514 configurations of FIG. 5 discussed below) may use one mode (e.g., a first person game mode) by default, and mobile configurations (e.g., mobile 516 configurations of FIG. 5 discussed below) may use another mode (e.g., a command mode) by default.

In one or more embodiments, a user playing a game can request help in the game from other users. The user can make such a request by providing any of various user inputs (e.g., providing a voice command, making a gesture, selecting a key sequence or menu option, and so forth). In response to such a request, virtual location information for the user is provided to virtual location check-in module 218. Alternatively, rather than providing the virtual location information for the user to module 218, a request to send out the notification can be provided to module 214, which uses the most recently provided virtual location information for the user. Virtual location notification module 214 sends a notification to other users as discussed above, but also includes an indication in the notification that the user is requesting help. This indication that the user is requesting help can take various forms, such as text (e.g., “Help!”), an image or graphic, a verbal recording of the user requesting help, and so forth. The recipients of the notification can then select the link included in the notification, and jump into the game at the location and/or in any of various modes as discussed above.

For example, assume game 204 is running on a gaming device A and that a user playing game 204 is getting overwhelmed by opponents. The user can request help from his or her friends, and in response to the request virtual location information is provided to virtual location check-in module 218 identifying a virtual location of the user of gaming device A. Virtual location notification module 214 provides a notification of this virtual location as well as the user's request for help to a friend of the user on a gaming device B. The notification includes a link that identifies functionality of module 214. The link is selected by the friend, and in response module 214 notifies gaming device B to begin running game 206 (which is the same game title as game 204) on gaming device B. Game 206 can be run in the same mode as game 204, and the friend is placed at the virtual location in game 206 that is the same virtual location as is identified in the notification. Accordingly, the friend can begin playing game 206 at the same virtual location as, and help, the user for which the notification was provided. Alternatively, game 206 can be run in a different mode as game 204, such as game 204 being run in a first person mode and game 206 being run in a command mode. The user of gaming device B can coordinate providing supplies or other support to the user of gaming device A to help the user of gaming device A with his or her gameplay.

Virtual location tracking module 212 allows the virtual locations of users in a virtual environment to be tracked. The virtual location information received by virtual location check-in module 218 for multiple users is maintained by module 212, and can be used to provide various gameplay features based on the virtual locations of users.

In one or more embodiments, virtual location tracking module 212 maintains a record of gameplay features, such as rewards or achievements, associated with different virtual locations. When virtual location information for a user is received by virtual location check-in module 218, virtual location tracking module 212 compares the virtual location of the user to the record of gameplay features, and if the virtual location of the user is the same as the recorded virtual location, then the gameplay feature is made available to the user. The gameplay feature can be made available to the user in different manners, such as virtual location tracking module 212 notifying the game 204 or 206, or gameplay service 112 of FIG. 1, that the feature is available to the user.

Whether the virtual location of the user is the same as the recorded virtual location can be identified in different manners. In one or more embodiments, if the virtual location of the user is within a threshold distance (e.g., using the coordinate system supported by virtual location system 202) of the recorded virtual location, then the virtual location of the user is the same as the recorded virtual location. Alternatively, whether the virtual location of the user is the same as the recorded virtual location can be determined in other manners, such as the virtual location of the user being the same as the recorded virtual location only if the virtual location of the user is the same as (e.g., equal to) the recorded virtual location.

The gameplay features and the virtual locations associated with those gameplay features can be identified in various manners. In one or more embodiments, the virtual locations and associated gameplay features are provided by the game title designer or developer.

In other embodiments, the virtual locations and associated gameplay features are provided by other users. In such embodiments, when a user is playing a game, the user can request that a gameplay feature be associated with a particular virtual location (e.g., the virtual location of the user at the time the request is made). The user can make such a request by providing any of various user inputs (e.g., providing a voice command, making a gesture, selecting a key sequence or menu option, and so forth). The gameplay feature requested by the user can take any of a variety of different forms, such as a verbal recording, a text description, an image or video sequence, and so forth. This gameplay feature is then made available to other users playing a game of the game title when virtual location check-in module 218 receives virtual location information for those other users identifying them as being at that particular virtual location.

The user can request that the gameplay feature be made available to all other users, or alternatively only particular users. The user can identify which particular users the gameplay feature is to be made available to in a variety of different manners. For example, the user can identify that the gameplay feature is to be made available only to friends of the user (e.g., as identified by online gaming service 104 of FIG. 1 or as identified by a social networking service), only to other users specified by the user (e.g., by entry of gamer tags, email addresses, etc. of the other users), and so forth. This gameplay feature is then made available only to those particular users playing a game of the game title when virtual location check-in module 218 receives virtual location information for those particular users identifying them as being at that particular virtual location.

It should be noted that a user can request that the same and/or different gameplay features be associated with multiple locations as he or she is playing the game. Different gameplay features can be associated with different virtual locations, such as particular verbal clues, passwords, video messages, and so forth. A user can also select to have a particular in-game item left as a gameplay feature (e.g., credits or other in-game currency can be debited from the user and left as a gameplay feature, weapons or other items can be left behind by the user as a gameplay feature, and so forth). Thus, as a user plays through a particular area of a game, he or she can leave various gameplay features for his or her friends to assist them in playing through that same area of the game.

Location conversion module 216 allows real world locations to be converted to virtual locations and/or virtual locations to be converted to real world locations. Various conversion techniques can be used to convert real world locations to virtual locations and/or vice versa, including various different rules, criteria, algorithms, and so forth. The particular techniques can vary based on the particular coordinate system used for the virtual environment and the particular coordinate system used for the real world. For example, module 216 can convert real world locations identified using a geographic coordinate system (e.g., with latitude, longitude, and elevation as the dimensions) to virtual locations using a Cartesian coordinate system including x, y, and z dimensions (e.g., horizontal, vertical, and depth).

This conversion between virtual locations and physical locations allows various gameplay features to be made available to users. A user can check in to a real world tracking service that provides various functionality to the user based on his or her physical location (the location of the user in the real world). The real world tracking service also provides the physical location and an identifier of the user such as a gamer tag, email address, or other user identifier (e.g., as provided by the user) to virtual location system 202. Location conversion module 216 receives the physical location and converts the physical location to a virtual location for the virtual environment. This converted virtual location is also maintained by virtual location tracking module 212 as a virtual location corresponding to a physical location at which the user has checked in.

In one or more embodiments, the gameplay features maintained and provided by virtual location tracking module 212 are associated with both a virtual location and a physical location. When virtual location information for a user is received by virtual location check-in module 218, virtual location tracking module 212 compares the virtual location of the user to the record of gameplay features. If the virtual location of the user is the same as the recorded virtual location, and the user has also checked in to a corresponding physical location, then the gameplay feature is made available to the user.

The gameplay features can be provided in different manners as discussed above, such as by a game title designer or developer. For example, a game title designer can have a particular gameplay feature (e.g., an achievement, a reward, a mini-game, etc.) that is made available to the user if the user has checked in at a virtual location where a particular landmark exists in the virtual environment (e.g., a particular battlefield, a particular monument, etc.) and has checked in at a physical location that corresponds to the virtual location where the particular landmark exists. When the user is traveling and checks in using a real world tracking service at that particular landmark, a record that the user has checked in at the corresponding virtual location is maintained by virtual location tracking module 212. If the user subsequently checks in at the virtual location where the particular landmark exists, then the particular gameplay feature is made available to the user.

In one or more embodiments, the gameplay features maintained and provided by virtual location tracking module 212 are associated with a virtual location that corresponds to a physical location. When virtual location information for a user is received by virtual location check-in module 218, virtual location tracking module 212 compares the virtual location of the user to the record of gameplay features. If the virtual location of the user is the same as the recorded virtual location, then the gameplay feature is made available to the user.

The gameplay features can be provided in different manners as discussed above, such as by another user. A user can check in to a real world tracking service that provides various functionality to the user based on his or her physical location as discussed above. The user can also request that a gameplay feature be associated with that physical location. The user can make such a request by providing any of various user inputs (e.g., providing a voice command, making a gesture, selecting a key sequence or menu option, and so forth). The gameplay feature requested by the user can take any of a variety of different forms, such as a verbal recording, a text description, an image or video sequence, and so forth. The real world tracking service provides the physical location and an identifier of the user as discussed above, as well as the gameplay feature requested by the user, to virtual location system 202. Location conversion module 216 receives the physical location and converts the physical location to a virtual location for the virtual environment. This converted virtual location is maintained by virtual location tracking module 212 as a virtual location corresponding to a physical location at which the user has checked in, and is associated with the gameplay feature requested by the user. This gameplay feature is then made available to other users playing a game of the game title when virtual location check-in module 218 receives virtual location information for those other users identifying them as being at that particular virtual location.

The user can request that the gameplay feature be made available to all other users, or alternatively only particular users. The user can identify which particular users the gameplay feature is to be made available to in a variety of different manners. For example, the user identify that the gameplay feature is to be made available only to friends of the user (e.g., as identified by online gaming service 104 of FIG. 1 or as identified by a social networking service), only to other users specified by the user (e.g., by entry of gamer tags, email addresses, etc. of the other users), and so forth. This gameplay feature is then made available only to those particular users playing a game of the game title when virtual location check-in module 218 receives virtual location information for those particular users identifying them as being at that particular virtual location.

By way of example, assume a user A is traveling and checks in using a real world tracking service at a particular street corner in Seattle, Wash. Further assume that the user records a verbal message for two of his or her friends, user B and user C. A record that the user has checked in at the virtual location corresponding to that particular street corner is maintained by virtual location tracking module 212. A record of the recorded verbal message is also maintained by module 212. When user B subsequently checks in at the virtual location in the virtual environment corresponding to that particular street corner, then the recorded verbal message is played back to user B.

In one or more embodiments, virtual location tracking module 212 tracks the virtual locations of multiple users in a virtual environment. The virtual locations of multiple users can be used to facilitate a user deciding at which virtual location of a virtual environment he or she desires to begin playing a game. The virtual locations of multiple other users are displayed to the user in various manners, such as using a “heat map” display that displays different portions of a map of the virtual environment in different colors or different color intensities based on how many other users are playing in the different portion. For example, a portion of the map can be highlighted in orange if 5-15 other users are playing the game at virtual locations in that portion, the portion of the map can be highlighted in red if 16 or more other users are playing the game at virtual locations in that portion, and so forth. Alternatively the virtual locations of multiple other users can be displayed to the user in other manners, such as a pin or dot displayed on the map for each other user, gamer tags or other identifiers of each of the users displayed on the map, and so forth. The multiple other users for which virtual locations are displayed can be identified in different manners, such as other users that are friends of the user (e.g., as identified by online gaming service 104 of FIG. 1 or as identified by a social networking service, etc.), other users in the same city or state (in the real world) as the user, other users having a skill level that is the same as (or within a threshold distance of) the user, and so forth.

The user can then select a particular portion or location of the map at which he or she desires to begin playing, in response to which the game begins playing at that portion or location. The user can make such a request by providing any of various user inputs (e.g., providing a voice command, making a gesture, selecting a key sequence or menu option, and so forth).

For example, a user can desire to play a game of a particular game title, and is presented with a heat map view of a map identifying the virtual locations where his or her friends are currently playing. The user can then select a location on the map where many of his or her friends are currently playing, and begin playing the game at that location.

Alternatively, rather than playing in the game, a user can request to observe the game being played by another user. The user can make such a request by providing any of various user inputs (e.g., providing a voice command, making a gesture, selecting a key sequence or menu option, and so forth). In response to such a request, as new virtual location information is provided by the other user, the virtual location of the other user is displayed to the requesting user. These virtual locations can be displayed, for example, on portions of a map of the virtual environment (e.g., the heat map), with or without the locations of other users.

In one more embodiments, the tracking of virtual locations of users by virtual location system 202 is performed only after receiving user consent to do so. This user consent can be an opt-in consent, where the user takes an affirmative action to request that the tracking of virtual locations be performed before virtual location system 202 performs any tracking of virtual locations of that user. Alternatively, this user consent can be an opt-out consent, where the user takes an affirmative action to request that the tracking of virtual locations of the user not be performed by virtual location system 202. If the user does not choose to opt out of this tracking, then it is an implied consent by the user to perform the tracking.

It should also be noted that various tracking of physical locations in the real world may be performed by other services or modules, and the tracking information received and maintained by virtual location system 202. This tracking of physical locations of users by virtual location system 202 can similarly be performed only after receiving user consent to do so.

Furthermore, it should be noted that the tracking of virtual locations of users by virtual location system 202 can allow system 202 to distinguish between different users, but need not include any personal information identifying particular users. For example, a user or user's device may log in to a service including virtual location system 202 with a particular user name or identity, but no association between that user name and the actual person need be maintained. Accordingly, virtual location system 202 can track virtual locations for a user, and at the same time have no knowledge of who that user actually is.

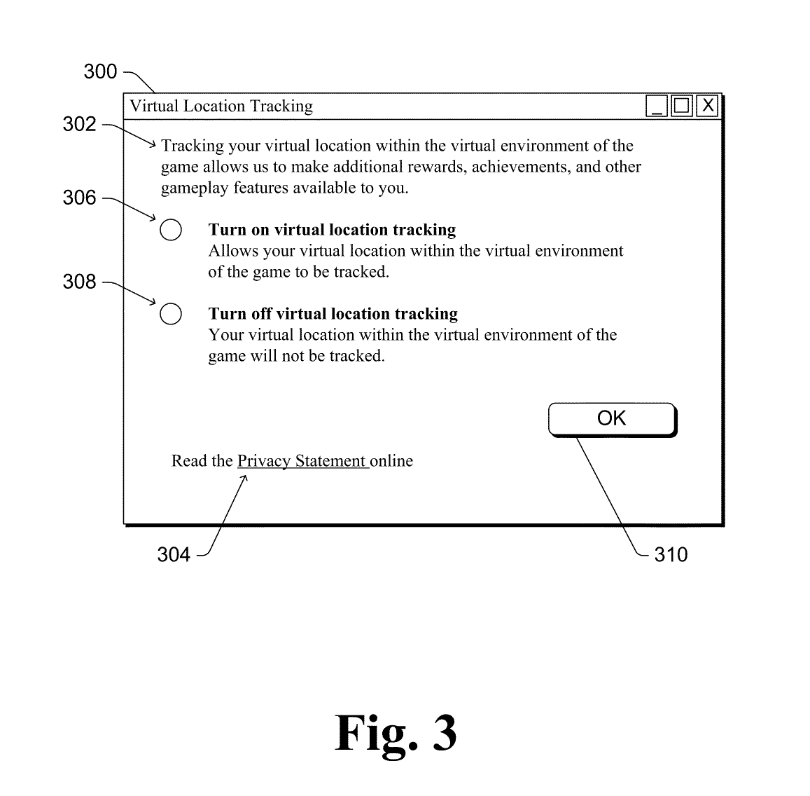

FIG. 3 illustrates an example user interface that can be displayed to a user to allow the user to select whether virtual location system 202 will track virtual locations of a user in accordance with one or more embodiments. A virtual location tracking window 300 is displayed including a description 302 explaining to the user why virtual location system 202 is performing the tracking. A link 304 to a privacy statement is also displayed. If the user selects link 304, a privacy statement of system 202 is displayed, explaining to the user how the user's information is kept confidential.

Additionally, the user is able to select a radio button 306 to opt-in to the tracking, or a radio button 308 to opt-out of the tracking. Once a radio button 306 or 308 is selected, the user can select an “OK” button 310 to have the selection saved. It is to be appreciated that radio buttons and an “OK” button are only examples of user interfaces that can be presented to a user to opt-in or opt-out of the tracking, and that a variety of other conventional user interface techniques can alternatively be used. Virtual location system 202 then proceeds to track or not track virtual locations of the user in accordance with the user's selection.

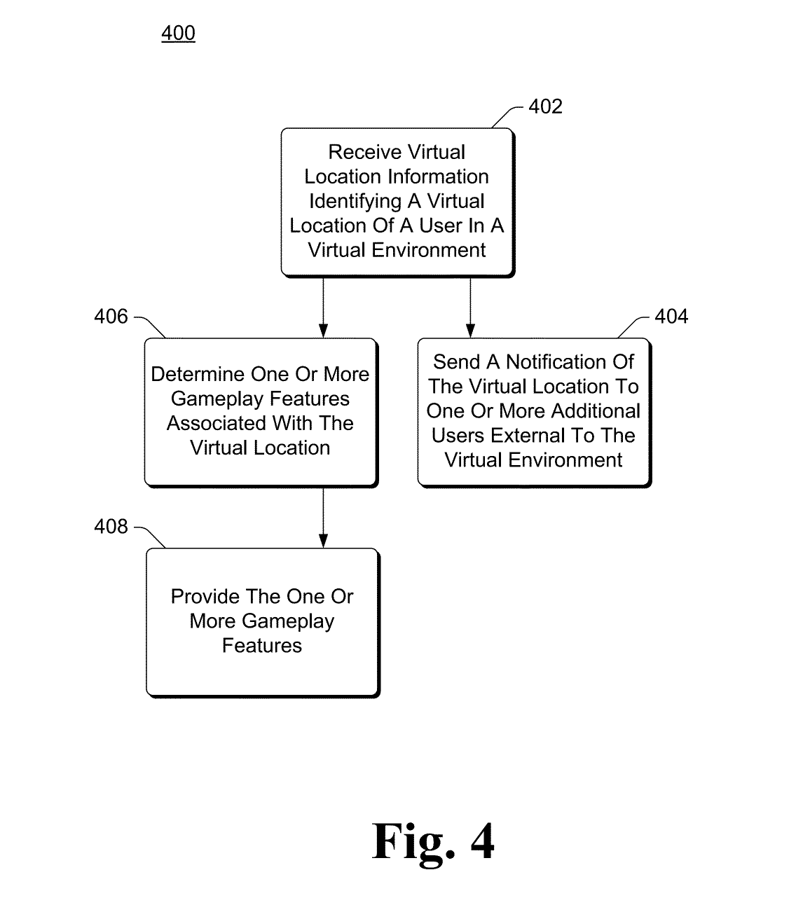

FIG. 4 is a flowchart illustrating an example process 400 for implementing the virtual location check-in in accordance with one or more embodiments. Process 400 is carried out by a virtual location system, such as system 200 of FIG. 2 or system 116 of FIG. 1, and can be implemented in software, firmware, hardware, or combinations thereof. Process 400 is shown as a set of acts and is not limited to the order shown for performing the operations of the various acts. Process 400 is an example process for implementing the virtual location check-in; additional discussions of implementing the virtual location check-in are included herein with reference to different figures.

In process 400, virtual location information identifying a virtual location of a user in a virtual environment is received (act 402). As discussed above, this virtual location information can include various information, including coordinates of the virtual location, an identifier of a game title implementing the virtual environment, an identifier of a map supported by the virtual environment, and so forth. This virtual location information can be received as part of a virtual location check-in request for a user, as discussed above.

Various actions can be taken based on the received virtual location information. A notification of the virtual location can be sent to one or more additional users external to the virtual environment (act 404). These one or more additional users are users that are not currently playing the game title implementing the virtual environment, as discussed above.

One or more gameplay features associated with the virtual location can also be determined (act 406) and provided to the user (act 408). Various different gameplay features, such as rewards or achievements, can be associated with different virtual locations, and these different gameplay features and associated virtual locations can be identified in different manners as discussed above.

Various actions such as communicating, receiving, sending, recording, obtaining, and so forth performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

FIG. 5 illustrates an example system generally at 500 that includes an example computing device 502 that is representative of one or more computing systems and/or devices that may implement the various techniques described herein. The computing device 502 may be, for example, a server of a service provider, a device associated with a user (e.g., a gaming device 102 of FIG. 1), an on-chip system, and/or any other suitable computing device or computing system.

Computing device 502 as illustrated includes a processing system 504, one or more computer-readable media 506, and one or more I/O Interfaces 508 that are communicatively coupled to one another. Although not shown, computing device 502 may further include a system bus or other data and command transfer system that couples the various components to one another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 504 is representative of functionality to perform one or more operations using hardware. Accordingly, processing system 504 is illustrated as including hardware elements 510 that may be configured as processors, functional blocks, and so forth. This may include implementation in hardware as an application specific integrated circuit or other logic device formed using one or more semiconductors. Hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

Computer-readable media 506 is illustrated as including memory/storage 512. Memory/storage 512 represents memory/storage capacity associated with one or more computer-readable media. Memory/storage 512 may include volatile media (such as random access memory (RAM)) and/or nonvolatile media (such as read only memory (ROM), Flash memory, optical disks, magnetic disks, and so forth). Memory/storage 512 may include fixed media (e.g., RAM, ROM, a fixed hard drive, and so on) as well as removable media (e.g., Flash memory, a removable hard drive, an optical disc, and so forth). Computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, a tactile-response device, and so forth. Thus, computing device 502 may be configured in a variety of ways as further described below to support user interaction.

Computing device 502 also includes a virtual location system 520. Virtual location system 520 provides virtual location functionality for different games of the same and/or different game titles. Virtual location system 520 is analogous to virtual location system 116 of FIG. 1, although is illustrated as implemented in computing device 502 rather than in an online gaming service. Virtual location system 520 can be virtual location system 202 of FIG. 2.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. Computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

In various implementations, computing device 502 may assume a variety of different configurations, such as for computer 514, mobile 516, and television 518 uses. Each of these configurations includes devices that may have generally different constructs and capabilities, and thus computing device 502 may be configured according to one or more of the different device classes. The techniques described herein may be supported by these various configurations of computing device 502 and are not limited to the specific examples of the techniques described herein. For instance, computing device 502 may be implemented as the computer 514 class of a device that includes a personal computer, desktop computer, a multi-screen computer, laptop computer, netbook, and so on.

Computing device 502 may also be implemented as the mobile 516 class of device that includes mobile devices, such as a mobile phone, portable music player, portable gaming device, a tablet computer, a multi-screen computer, and so on. Computing device 502 may also be implemented as the television 518 class of device that includes devices having or connected to generally larger screens in casual viewing environments. These devices include televisions, set-top boxes, gaming consoles, and so on.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving, at one or more devices, virtual location information identifying a virtual location of a user in a virtual environment;
sending, from the one or more devices, a notification of the virtual location of the user in the virtual environment to one or more additional users external to the virtual environment; and
providing an item associated with the user in the virtual environment to the one or more additional users in response to the one or more additional users accessing the virtual location.

2. A method as recited in claim 1, the virtual location information including coordinates identifying the virtual location and an identifier of a game title implementing the virtual environment.

3. A method as recited in claim 1, the notification including a user-selectable link embedding the virtual location.

4. A method as recited in claim 3, further comprising notifying, in response to receiving an indication from an additional device of a user selection of the user-selectable link, the additional device to jump to the virtual location of a game of a game title identified by the user-selectable link.

5. A method as recited in claim 1, further comprising identifying a recorded virtual location that is the same as the virtual location, and making a gameplay feature associated with the virtual location available to the user in response to the recorded virtual location being the same as the virtual location.

6. A method as recited in claim 5, further comprising:
receiving information identifying a physical location of the user in the real world;
determining an additional virtual location corresponding to the physical location; and
making the gameplay feature available to the user only if the recorded virtual location is the same as the virtual location and the additional virtual location is the same as the recorded virtual location.

7. A method as recited in claim 5, the gameplay feature comprising a gameplay feature provided by an additional user, the gameplay feature including a verbal recording, a text description, an image, or a video sequence.

8. A method as recited in claim 7, the additional user having provided multiple gameplay features associated with multiple virtual locations in the virtual environment.

9. A method as recited in claim 1, the notification including an indication that the user is requesting help.

10. A method as recited in claim 9, further comprising notifying, in response to an indication of recipient selection of a link in the notification, a device of the recipient to begin running a game implementing the virtual environment in a same mode as a device running a game implementing the virtual environment for the user, the recipient being one of the one or more additional users, the mode being selected by the user to indicate that the one or more additional users external to the virtual environment begin running the game in either a first person mode or a command mode.

11. A method as recited in claim 9, further comprising notifying, in response to an indication of recipient selection of a link in the notification, a device of the recipient to begin running a game implementing the virtual environment in a mode dependent on a configuration of the device, the recipient being one of the one or more additional users.

12. A method as recited in claim 1, further comprising, prior to the receiving and the sending, generating a heat map for display, the heat map identifying virtual locations of multiple users in a virtual environment via different color intensities, each different color intensity being based on a number of the multiple users at a particular virtual location.

13. One or more computer-readable storage media having stored thereon multiple instructions that, when executed by one or more processors of a computing device, cause the one or more processors to:
receive a virtual location check-in request for a first user, the virtual location check-in request including virtual location information identifying a first virtual location of the first user in a virtual environment;
receive information identifying a physical location of the first user in the real world;
determine a second virtual location corresponding to the physical location; and
provide, based on the first virtual location identified in the virtual location check-in request being a same virtual location as the second virtual location, one or more gameplay features.

14. (canceled)

15. One or more computer-readable storage media as recited in claim 13, the multiple instructions further causing the one or more processors to:
receive information identifying a physical location of a second user in the real world;
determine a second virtual location corresponding to the physical location; and
provide the one or more gameplay features to the second user only if the first virtual location and the second virtual location are the same virtual location.

16. One or more computer-readable storage media as recited in claim 13, the one or more gameplay features comprising one or more gameplay features provided by a second user.

17. One or more computer-readable storage media as recited in claim 16, the second user having provided multiple gameplay features associated with multiple virtual locations in the virtual environment.

18. One or more computer-readable storage media as recited in claim 13, the virtual location information including coordinates identifying the first virtual location and an identifier of a game title implementing the virtual environment.

19. One or more computer-readable storage media as recited in claim 13, the multiple instructions further causing the one or more processors to send a notification of the virtual location of the first user in the virtual environment to one or more additional users external to the virtual environment.

20. One or more computer-readable storage media having stored thereon multiple instructions that, when executed by one or more processors of one or more computing devices, cause the one or more processors to:
receive, at the one or more computing devices, virtual location information identifying a virtual location of a user in a virtual environment, the virtual location information including coordinates identifying the virtual location and an identifier of a game title implementing the virtual environment; and
send, from the one or more computing devices to one or more additional users external to the virtual environment, a notification including an indication that the user is requesting help in the virtual environment, the notification including a user-selectable hyperlink embedding both the virtual location and the identifier of the game title.

21. One or more computer-readable storage media as recited in claim 13, the multiple instructions further causing the one or more processors to implement an application programming interface (API) to receive the first virtual location of the first user in the virtual environment.
